(19) United States
(12) Patent Application Publication
(10) Pub. No.: US 2026/0358999 A1
(43) Pub. Date: Nov. 12, 2026

(54) SYSTEMS AND METHODS FOR AUDIO BUS MANAGEMENT

(71) Applicant: Tymphany HK Limited, Wanchai (HK)

(72) Inventors: Dimitar Georgiev Gritsnelov, Taipei City (TW); Gavin Jones, Taipei City (TW); John Evan Bunner, Taipei City (TW); YU RAO, Taipei City (TW)

(21) Appl. No.: 19/371,999

(22) Filed: Oct. 28, 2025

Related U.S. Application Data
(60) Provisional application No. 63/736,950, filed on Dec. 20, 2024.

(51) Int. Cl. G06F 3/16; B60K 35/26

(52) U.S. Cl. CPC G06F 3/165; B60K 35/26; B60K 2360/18; B60K 2360/583

(57) ABSTRACT

A system, and method, for an audio system for a vehicle includes a central unit configured to communicate audio signals over at least one bus, the at least one bus including a first master bus, wherein the first master bus includes a first plurality of nodes; a first master transceiver corresponding to a node of the first plurality of nodes; a controller, wherein the controller is configured to generate control signals for coordinating at least some of the audio signals; a digital signal processor (DSP) in communication with the controller and the first master transceiver; and a second master transceiver corresponding to an initial node of a second plurality of nodes comprised by a second master bus, the second plurality of nodes being linked to the first plurality of nodes through the node.

### CROSS REFERENCE TO RELATED APPLICATIONS

This application claims priority of U.S. Provisional Application No. 63/736,950 filed on Dec. 20, 2024 under 35 U.S.C. § 119(e), the entire contents of which are hereby incorporated by reference.

### BACKGROUND OF THE INVENTION

### Field of the Invention

The present invention related to audio systems and, more particularly, to a system and method for audio bus management in a vehicle audio system.

### Description of the Related Art

Modern automotive and industrial audio systems often involve the transmission of high-fidelity audio signals with control signals through various devices such as microphones, sensors, amplifiers, speakers, and multimedia systems. These systems often rely on two-wire communication methods such as Inter-IC Sound (I2S), time division multiplexing (TDM), or proprietary communication buses. However, these methods can involve complex wiring harnesses, increased system cost, and limitations in scalability, distance, and EMI (Electromagnetic Interference) performance.

To address these challenges, digital audio transceivers and buses such as Analog Devices' Automotive Audio Bus (A²B™) have been developed. A²B is a high-bandwidth, bidirectional, serial communication bus that allows the transmission of digital audio, control data, and power over a single, unshielded twisted pair (UTP) cable. A²B transceivers can be configured in either master or slave, as in a master-slave network, where a central processor (the master) can communicate with multiple peripheral devices (sub nodes and/or slaves) such as digital microphones or amplifiers. This topology significantly reduces cabling complexity and weight, which can be important to automotive applications.

Despite the benefits offered by A²B and similar technologies, existing implementations still face challenges related to adaptability and scalability. For example, the existing A²B transceivers and bus system have a limited capacity of audio channels and adding additional sub nodes transceiver (e.g., slave transceivers) at various locations of the network topology can be challenging.

### SUMMARY OF THE INVENTION

The present inventors have recognized a need for improved systems and methods for managing audio buses that enhance flexibility, reliability, and integration with heterogeneous audio and control subsystems.

According to a first exemplary aspect of the present invention, an audio system, for a vehicle, includes a central unit configured to communicate audio signals over at least one bus, the at least one bus comprising a first master bus, wherein the first master bus comprises a first plurality of nodes; a first master transceiver corresponding to a node of the first plurality of nodes; a controller in communication with the central unit and the first master transceiver, wherein the controller is configured to generate control signals for coordinating at least some of the audio signals; a digital signal processor (DSP) in communication with the controller and the first master transceiver, wherein the DSP is configured to communicate a portion of the audio signals with the first master transceiver; and a second master transceiver corresponding to an initial node of a second plurality of nodes comprised by a second master bus, the second plurality of nodes being linked to the first plurality of nodes through the node, wherein the second master transceiver is in communication with the DSP and the controller to communicate the at least some of the audio signals and the control signals with the second plurality of nodes via the second master bus.

According to a second exemplary aspect of the present invention, a method, for a vehicle audio system, includes communicating, via a central unit, audio signals over at least one bus, the at least one bus comprising a first master bus, wherein the first master bus comprises a first plurality of nodes; linking, to the first master bus, a first master transceiver corresponding to a node of the first plurality of nodes; generating, via a controller, control signals for coordinating at least some of the audio signals; linking a digital signal processor (DSP) in communication with the controller and the first master transceiver, the DSP configured to communicate a portion of the audio signals with the first master transceiver; and linking a second master transceiver corresponding to an initial node of a second plurality of nodes comprised by a second master bus, the second plurality of nodes being linked to the first plurality of nodes through the node, wherein the second master transceiver is in communication with the DSP and the controller to communicate the at least some of the audio signals and the control signals with the second plurality of nodes via the second master bus.

According to a third exemplary aspect of the present invention, an audio system, for a vehicle, includes a central unit configured to communicate audio signals and control signals over at least one bus, the at least one bus comprising a first master bus, wherein the first master bus comprises a first plurality of nodes; a first master transceiver corresponding to a node of the first plurality of nodes; a controller in communication with the central unit and the first master transceiver, wherein the controller is further configured to receive information from the first master transceiver and downstream device information to generate control signals for coordinating at least some of the audio signals; a digital signal processor (DSP) in communication with the controller and the first master transceiver, the DSP configured to communicate a portion of the audio signals with the first master transceiver; and a second master transceiver corresponding to an initial node of a second plurality of nodes comprised by a second master bus, the second plurality of nodes being linked to the first plurality of nodes through the node. The second master transceiver is in communication with the DSP and the controller to communicate the at least some of the audio signals and the control signals with the second plurality of nodes via the second master bus. The second master transceiver communicates the downstream device information with the controller. The DSP is configured with loopbacks for coordinating clock signals between the controller, the DSP, and the first and second master transceivers.

### BRIEF DESCRIPTION OF THE DRAWINGS

The accompanying drawings, which are incorporated in and constitute a part of this disclosure, illustrate various disclosed embodiments. In the drawings:

FIG. 1 is a diagram illustrating an example audio system, consistent with some previous systems;

FIG. 2A is a diagram illustrating an example audio system, consistent with some disclosed embodiments;

FIG. 2B is a diagram illustrating an example audio system with a transceiver unit having two master transceivers, consistent with some disclosed embodiments;

FIG. 3 is a diagram illustrating an example of clock signaling in an audio system, consistent with some disclosed embodiments;

FIG. 4 is a diagram illustrating another example of an audio system with two master transceivers, consistent with some disclosed embodiments;

FIG. 5 is a diagram illustrating an example implementation of an audio system in a vehicle, consistent with some disclosed embodiments; and.

FIG. 6 is a flowchart illustrating a process for implementing an audio system in a vehicle, consistent with some disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Disclosed systems and methods are intended to address some issues with existing audio bus (e.g., A²B) architectures, particularly those related to adaptability and scalability in distributed audio environments. Conventional systems suffer from constrained audio channel capacity and rigid topological configurations that hinder the insertion of additional sub nodes and/or slave transceivers within intermediate nodes. To overcome these deficiencies, the present invention introduces a dual audio transceiver and audio bus configuration designed to facilitate segmented audio routing, dynamic node expansion, and multi-path communication. This approach enables flexible integration of heterogeneous audio and control subsystems by improving adaptability without interfering with the operation of established audio system operation and hierarchies. Disclosed embodiments support increased flexibility, adaptable channel allocation, redundancy mechanisms, and fault-tolerant operation, thereby enhancing overall reliability and providing a scalable foundation for vehicle audio systems.

It should be understood that the terms sub nodes, slaves, sub node transceivers, slave transceivers and the like may be used interchangeably with respect to the disclosed embodiments. A sub node may refer to a component or device within a larger network or system that performs specific tasks, communicates with other nodes, and may operate under the coordination of a central or parent node. As used herein, slaves and/or slave transceivers may act as sub nodes in the system, or may act as nodes downstream of the sub nodes. A master node may refer to the central or primary controller in a hierarchical or distributed system that manages and coordinates the activities of subordinate nodes (such as slave or sub nodes). As used herein, a master node may include nodes which act as parents to other nodes.

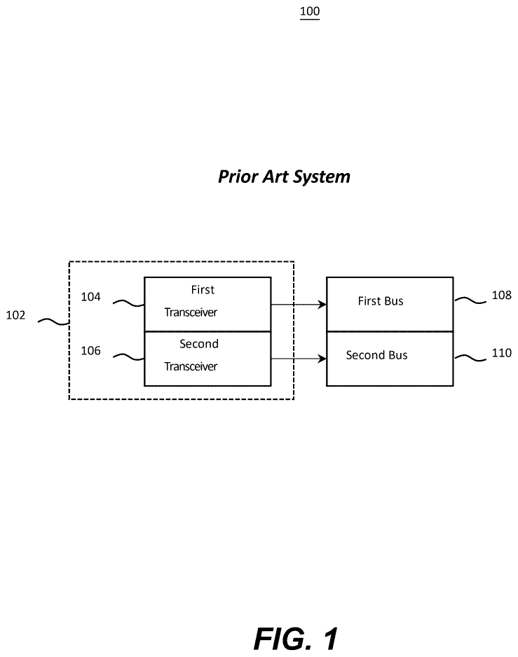

FIG. 1 is a diagram illustrating example audio system 100, consistent with some previously available systems. Multimedia system 102 may produce audio signals, control signals, or any combination therein. These signals may be communicated with first transceiver 104 or second transceiver 106 in any combination. First transceiver 104 is used to communicate with devices through first bus 108. Likewise, second transceiver 106 is used to communicate with device through second bus 110. The first and second buses 108, 110 include a plurality of nodes configured to communicate first and second transceivers 108, 110 with various peripheral devices. Information between multimedia system 102, first and second transceivers 108, 110, and the peripheral devices may travel upstream back toward multimedia system 102 or downstream toward peripheral devices. Devices associated with first bus 108 and second bus 110 may refer to any device configured to communicate audio or control signals with multimedia system 102. For example, such devices may include sensors (e.g., accelerometers, pressure sensors, motion sensors) or audio devices (e.g., I/O devices, microphones, speakers).

As shown in FIG. 1, multimedia system 102 includes both first transceiver 104 and second transceiver 106. In this system, first transceiver 104 and second transceiver 106 need to be configured on the same electronic chip, limiting adaptability and flexibility of the system to any changes in first bus 108 or second bus 110, or the addition of new buses. Other systems of first transceiver 104 or second transceiver 106 may be used, including use of only one master transceiver, daisy chained to sub nodes (e.g., sub node transceivers) and/or slave transceivers on first bus 108 or second bus 110. For example, in a daisy chain configuration, each sub node may be configured to receive downstream frames from its immediate upstream node and to transmit upstream frames toward the master transceiver. To ensure deterministic latency across the chain, the system may operate in discrete time slots, each including a frame where all signals and devices communicate in a synchronized frame. All sub nodes may process audio data within the same superframe, thereby ensuring that each node receives an identical audio sample during a given bus cycle. Unlike traditional audio buses that suffer from node-to-node latency accumulation due to buffering or clock skew, audio buses using master transceiver 104 and master transceiver 106 as master nodes may enable synchronous delivery across all nodes with a single cycle of end-to-end latency. This approach may be especially advantageous in automotive environments where precise timing alignment is desirable, such as multi-microphone noise suppression systems, spatial audio processing, or distributed voice capture arrays. However, such systems are still limited in communication bandwidth and number of communication channels. For example, A²B transceivers presently support high-throughput operation, with aggregate data rates on the order of 50 Mbps, but recent versions support just up to 32 discrete audio channels per bus segment. Another limitation of previous systems is that branching is restricted to specific points in the chain of nodes (i.e., in a bus) and you cannot branch from the last node in the chain, limiting expansion and scalability.

Disclosed embodiments describe systems and methods that improve upon existing systems (such as example audio system 100) and methods, by increasing flexibility and adaptability to changes in the system. For example, disclosed embodiments enable adding additional buses linked to existing buses, and additional nodes, sub nodes, or individual peripheral devices to be configured in the same system more efficiently and economically. In this way, devices can be easily removed, added, or changed in the audio system with improved flexibility and adaptability.

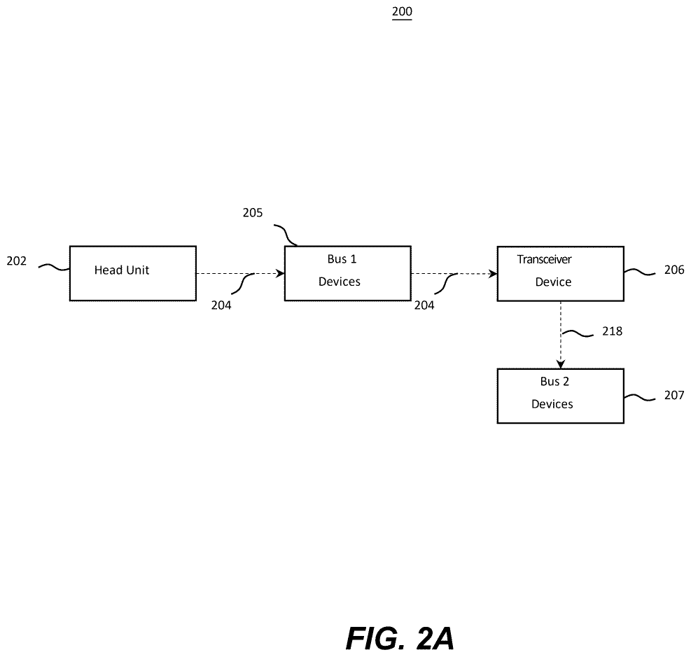

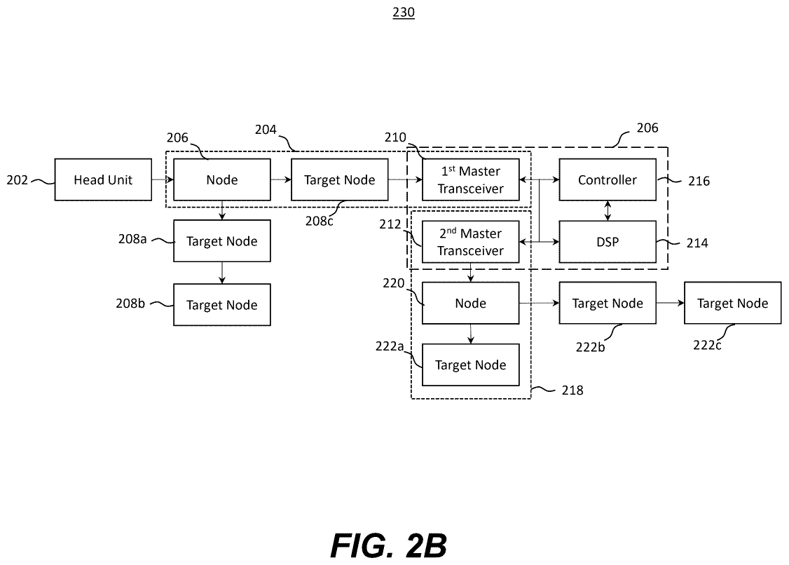

FIG. 2A is a diagram illustrating example audio system 200, consistent with some disclosed embodiments. Central unit 202 may be configured to communicate one or more audio signals and/or control signals through first master bus 204 to transceivers comprised in transceiver device 206, which may further communicate one or more audio signals and/or control signals through second master bus 218.

Central unit 202 may refer to a central electronic device in a vehicle that functions as the primary interface and control system for multimedia, audio playback, navigation, or related infotainment functions. For example, central unit 202 may refer to a head unit, car stereo, audio system, infotainment system, multimedia system, dashboard control unit, central media system, central system processing unit, smart amplifier, or any module or device configured to act as a central device in a vehicle system capable of handling audio signaling. Central unit 202 may include one or more user interface components such as a touchscreen display, physical buttons, rotary dials, or voice control modules, and may be integrated into the vehicle's dashboard or instrument panel. Central unit 202 may include processing circuitry configured to manage audio sources, signal routing, user preferences, and system diagnostics. Central unit 202 may communicate with other vehicle subsystems via communication buses such as controller area network (CAN), media-oriented systems transport (MOST), A²B, or ethernet, and may also support wireless protocols including Bluetooth®, Wi-Fi®, or cellular LTE. For example, central unit 202 may receive audio input from a smartphone via Bluetooth, process the signal, and transmit the resulting audio to various speaker zones within the vehicle. In another example, central unit 202 may execute voice assistant software to allow a driver to initiate phone calls, adjust media playback, or control vehicle functions through natural language commands. Central unit 202 may further include storage media, navigation modules, or connectivity to cloud-based services, and may operate as a master controller in distributed audio systems comprising amplifiers, microphones, peripheral transceivers, etc.

In some embodiments, central unit 202 may include functionality or structure similar to that of multimedia system 102 in FIG. 1. In some embodiments, central unit 202 may functionally and/or structurally differ from multimedia system 102. For example, central unit 202 may not include master transceivers or any other various controllers or components.

Bus 1 devices 205 may link to first master bus 204 and include, for example, peripheral devices (e.g., audio devices or sensors) and/or sub nodes configured to communicate with peripheral devices, or any combination therein. For example, sub nodes may include secondary or auxiliary nodes that are logically or physically connected downstream of a master node. Sub nodes may include sub nodes or may interface with peripheral devices. For example, peripheral devices may include sensors (e.g., accelerometers, pressure sensors, motion sensors) or audio devices (e.g., I/O devices, microphones, speakers).

Bus 1 devices 205 may be configured at any node (e.g., intermediary or intervening nodes) along first master bus 204. For example, one device may be linked through an intermediary node on first master bus 210. The intermediary node may be a sub node and/or a smart node, and/or a dumb node. A smart node may refer to any active node in the system. A dumb node may refer to a node in which the signals are simply relayed through the node. For example, the dumb node may include a simple electronic device interfacing with the audio system wires, or the dumb node may include a crossing of wires, acting as a node.

Transceiver device 206 may be configured to communicate a portion of audio and control signals through second master bus 218 to bus 2 devices 207 or associated sub nodes. Bus 2 devices 207 may include similar types of nodes and devices as bus 1 devices 205. The portion of signals may include some or all of the signals. Transceiver device 206 may be configured, for example, to allow for placement anywhere along first master bus 204. This may allow transceiver device 206 to operate as master or slave (e.g., sub node), or both, and to provide the capability for adding a branching bus (e.g., second master bus 218) at any node in the plurality of nodes included in first master bus 204. For example, transceiver device 206 may be on one bus, and another transceiver device may be on the other bus. Transceiver device 206 may then communicate audio and/or control signals to a plurality of nodes included in second master bus 218.

Central unit 202 may be configured specifically to interact with transceiver device 206. For example, central unit 202 may include a transceiver which acts as a master transceiver for the network of nodes in example audio system 200. The master transceiver may initialize and configure its downstream network of nodes, enumerating each downstream sub node along the chain or network. For example, central unit 202 may include a master transceiver (e.g., A²B transceiver and A²B audio bus operable using software such as Sigma Studio©) configured to communicate information through two or more transceivers included in transceiver device 206. In some embodiments, central unit 202 may be configured to communicate audio signals over at least one bus, the at least one bus comprising first master bus 204, wherein first master bus 204 may include a first plurality of nodes. Audio signals may include any signals associated with audio devices or sensors in the vehicle, for example, accelerometers, pressure sensors, motion sensors, I/O devices, microphones, speakers, etc. Central unit 202 may also communicate control signals that may include control signals for synchronization, timing, downstream peripheral device information, communication channels, registers, etc.

The plurality of nodes may be any nodes corresponding with bus 1 devices 205, bus 2 devices 207, or a master transceiver included in transceiver device 206. For example, transceiver device 206 may be configured as a node linking master buses 204, 218. The plurality of nodes may correspond to a device in central unit 202, transceiver device 206, bus 1 devices 205, or bus 2 devices 207 and may include master or sub nodes, or associated sub-node devices such as microphones, amplifiers, or sensors. The plurality of nodes may be configured on master buses 204, 218 to form linear, daisy-chained topology using an unshielded twisted pair (UTP) cable that may carry power, clock, data, and control signals between nodes.

The configuration of transceiver unit 206 is described in further detail with respect to FIGS. 2B to 5.

FIG. 2B is a diagram illustrating an example audio system 230 with transceiver device 206 having two master transceivers 210, 212, consistent with some disclosed embodiments. Certain features of the system of FIG. 2B are shared with the audio system 200 in FIG. 2A.

Central unit 202 may be configured to communicate audio and/or control signals via first master bus 204 with a plurality of nodes including node 206 (i.e., an intermediary or intervening node), target nodes 208a, 208b, 208c, and first master transceiver 210 in transceiver device 206.

Transceivers first master transceiver 210 and second master transceiver 212 may be communication devices configured to initiate, control, and manage data transmission over a serial audio bus within a vehicle audio system. The transceivers may be A²B transceivers or a functionally equivalent devices capable of serving as a node (typically an initiating node) in a daisy-chained or multi-drop digital audio network. The transceivers are operatively coupled to one or more sub nodes (e.g., slave nodes) via a physical medium such as an unshielded twisted pair (UTP) cable, over which they transmit audio signals, control signals (e.g., clock signals), or power. Such sub nodes may communicate audio and control signals with one or more peripheral devices (e.g., audio devices or sensors). The transceivers may be integrated into a central unit, central processor, or audio gateway module and can be configured to enumerate, synchronize, and manage downstream sub nodes in the network. For example, the master transceiver may establish a timing reference for the bus, assign logical addresses to sub nodes (e.g., sensors, microphones, amplifiers, or speaker modules), and handle bidirectional communication through time-division multiplexing. In certain implementations, the transceivers may be configured to detect faults, initiate diagnostics, and adapt the bus configuration based on system conditions or user input, among other things.

Transceivers first master transceiver 210 and second master transceiver 212 may implement one or more digital audio protocols, including but not limited to inter-integrated circuit (I²C), I²S, or TDM, depending on system architecture and performance specifications. Each transceiver may communicate through a serial peripheral interface (SPI) and include multiplexing to distribute audio and control signals across different channels. In embodiments utilizing I²S or TDM, the master transceiver generates timing signals such as bit clock (BCLK), word select (WS), and frame synchronization signals, which define the data structure and timing for downstream slave audio devices such as digital microphones, amplifiers, or digital to analog converters (DACs). For example, in a TDM-based system, the transceivers may allocate discrete time slots to multiple slave devices within a shared serial data stream, allowing for the simultaneous transport of multi-channel audio. In I²S implementations, the transceivers may communicate with individual point-to-point devices using a dedicated clock and data line. In both cases, the transceivers may be configured to maintain synchronization of their affiliated devices, initializing connected devices, and optionally managing mute, gain, or error correction functions, among other things.

When used in conjunction with other systems such as A²B, the transceivers may additionally provide power and handle automated enumeration and topology discovery over single physical interfaces. Accordingly, the transceivers may act as a central coordinating entity for timing, data framing, and bus integrity in a variety of serial digital audio architectures employed in vehicle environments.

In FIG. 2B, first master transceiver 210 is located at the terminal node of first master bus 204. However, this is not intended as limiting, and according to some embodiments, first master transceiver 210 may be located at any node in the plurality of nodes. For example, first master transceiver 210 may be positioned at an alternative node in first master bus 204, with additional nodes or target nodes located downstream of first master transceiver 210 as determined moving along the bus away from central unit 202.

Transceiver device 206 (e.g., an audio device for improving adaptability of audio buses in a vehicle) may include a second master transceiver 212, DSP 214 for processing audio signals, and controller 216 for generating control signals for second master transceiver 212, among other things.

Second master transceiver 212 may comprise, for example, an initial node or initial node of second master bus 218. Second master bus 218 may be configured to communicate audio and/or control signals from DSP 214 and controller 216 to node 220 and/or target nodes 222a, 222b, 222c. As discussed with respect to FIG. 2A, first master bus 204 and second master bus 218 may be A²Bs and configured to work with first master transceiver 210 and second master transceiver 212, which may be A²B transceivers.

In some embodiments, first master transceiver 210 may be configured to communicate audio signals directly with central unit 202. For example, first master transceiver 210 (or controller 216) may be positioned as a first node or initial node of first master bus 204 and audio and control signals may pass directly from central unit 202 through first master transceiver 210, which may allocate the signals through communication channels to each node, along first master bus 204 or any sub nodes therein. In another example, first master transceiver 210 may be positioned at another node (i.e., not the initial node) on first master bus 204 and may communicate directly with central unit 202 to communicate audio signals for further downstream audio devices. In this way, first master transceiver 210, participates with the central unit 202 in coordinating communication of audio and control signals through communication channels in the network. In some embodiments, first master transceiver 210 may be configured to recognize the presence of transceiver unit 206 and adjust signaling to accommodate for its demands. For example, in an A²B audio system, an A²B transceiver (e.g., a transceiver in central unit 202) may automatically discover and configure connected slave devices when the system powers up. It may send discovery signals along the bus, assign addresses, and manage each node using embedded I²C communication. If a device is added or removed, the system can detect changes through signal and response checks, though it's not typically designed for hot-swapping in automotive setups. In some embodiments, controller 216 may be connected to two master transceivers (e.g., over I²C), and may detect the presence of a second master bus (e.g., via a signal input such as a mechanical switch, general purpose input output (GPIO), or voltage condition). For example, first master transceiver 210 may be a part of first master bus 204 and remain active at all times. Then, when second master bus 218 is connected, controller 216 may execute code to activate second master transceiver 212, dynamically launching second master bus 218 and expanding the audio network beyond standard topology.

In some embodiments, controller 216 may be in communication with central unit 202 and first master transceiver 210. Controller 216 may be configured to generate control signals for coordinating at least some of the audio signals. For example, controller 216 may communicate the control signals using I²C or SPI, while audio signals may be communicated via Inter-IC Sound (I²S). This configuration is not intended as limiting, and in some embodiments, the control and audio signals may be mixed and communicated with other protocols may be used. For example, universal asynchronous serial port (UART), GPIO, secure digital input output (SDIO), controller area network (CAN), etc. It should be understood that controller 216 may be operable in other types of audio systems with other types of master transceivers, for example, audio video bridging (AVB™)or Dante™ systems.

Controller 216 may be connected to first and second master transceivers 210, 212 via an interface such as I²C. For example, controller 216 may be configured to initiate second master bus 218 using the Discovery Flow as defined in Analog Devices' technical documentation (e.g., for AD243x transceivers). Controller 216 may monitor system conditions such as connector status, GPIO inputs, or other relevant triggers, and upon determining that second master bus 218 is included, may issue standard I²C commands to initiate the appropriate discovery sequence for sub nodes. These commands may include writing to discovery control registers to launch either Simple or Optimized Discovery Flows, optionally configuring node addressing, clock roles, or channel maps, and reading status flags to confirm discovery completion and verify node connectivity. For example, controller 216 may utilize the built-in capabilities of A²B transceivers to dynamically extend the audio bus, which may enable the activation of a second A²B segment, driven by second master transceiver 212, in response to physical or logical system events, without performing a full system reboot.

In some embodiments, controller 216 may be configured to communicate control signals only through first master transceiver 210, while in some other embodiments, controller 216 may be configured to communicate the audio signals directly with central unit 202 and directly with first master transceiver 210. For example, controller 216 may be responsible for coordinating audio signals to or from DSP 214 or first master transceiver 210, even where controller 216 does not handle or process the audio signals. For example, controller 216 may be configured as part of first master bus 204 in lieu of or in combination with first master transceiver 210. This configuration may allow for controller 216 to receive (e.g., directly) and coordinate audio signals and control signals from central unit 202. For example, controller 216 may be configured to use the audio signals and control signals to determine how communication should be coordinated for devices associated with second master bus 218.

Controller 216 may also be configured to handle dynamic switching between locally powered and bus-powered configurations of transceiver device 206. For example, controller 216 may monitor power availability and control internal power routing logic. In locally powered mode, transceiver device 206 may draw power from a dedicated supply, offering greater stability and isolation. In bus-powered mode, it may rely on voltage supplied through the first master bus 204. Controller 216 may be configured to detect voltage thresholds or manage power sequencing. Controller 216 may be configured to use integrated power management circuitry, fault detection, and possibly hot-swap support.

Controller 216 may be configured to determine whether transceiver device 206 operates as a master or slave unit (e.g., master or sub node) based on the desired topology and communication pathways within the audio system. For example, the relative position of transceiver device 206 (and first master transceiver 210) within the daisy chain of first master bus 204 may determine whether transceiver device 206 operates as a master or sub node device. During system initialization or configuration, controller 216 may transmit a set of configuration parameters to first master transceiver 210, DSP 214, or second master transceiver 212 over a control interface such as I²C. These parameters may include role designation flags that dictate whether transceiver device 206 asserts or listens to the audio system clock signals, as well as whether it sources or sinks the digital audio stream on first master bus 204 or second master bus 218. For example, role designation may be determined via physical connector state, clock presence detection, or static configuration, etc. In any configuration, both master transceivers 210, 212 may be active simultaneously.

In some embodiments, transceiver device 206 may be configured to operate in a master mode. When designated as a master, transceiver device 206 may be configured to generate the timing signals (e.g., via a clock crystal in transceiver device 206) for the audio network, drive devices on first master bus 204 or second master bus 218, and/or initiate the discovery and enumeration process for downstream sub nodes (using first or second master transceivers 210, 212 or controller 216). For example, when transceiver device 206 operates in master mode, it may be configured to assume control of the audio network by generating the system clock and synchronization signals for all downstream slave devices. It may be configured to perform network discovery for the overall audio system to identify and configure connected nodes, assign addresses, and manage audio and control data. Acting as the central coordinator, it may also supply power to sub nodes and ensure deterministic latency and real-time performance across the bus. For example, in master mode, transceiver device 206 may be an initial node of first master bus 204.

In some embodiments, transceiver device 206 may be configured to operate in a slave mode. As a slave, transceiver device 206 may be configured to synchronize its internal clock circuits to the incoming clock from the upstream master (e.g., a master transceiver in central unit 202) and wait for address and configuration instructions to be used by controller 216 for further distribution and coordination via control signals. This flexible role assignment helps allow for dynamic and hierarchical configurations in the audio system, tailored to specific architectures or needs in the audio system (e.g., in a particular vehicle). For example, transceiver device 206 may be configured to operate as a subordinate node that receives clock and synchronization signals from a master transceiver or central unit 202. In this mode, transceiver device 206 may not initiate or communication via first master transceiver 210, but instead may respond to commands and data routing established by the master. Transceiver device 206 in slave mode may use controller 216 to coordinate

Central unit 202 may include digital signal processor (DSP) 214 to enable efficient and distributed audio signal processing across multiple zones or components within the vehicle. DSP 214 may also be located in a central unit, such as a telematics control unit (TCU), or an amplifier module, and may interface with a communication bus (e.g., master bus) or network that connects remote audio nodes throughout the vehicle. The communications bus may thus be configured to carry digital audio data, control commands, synchronization signals, etc. between DSP 214 and peripheral devices, such as microphones, speakers, amplifiers, and sensors. Notable, although DSP 214 is described as included with central unit 202, DSP 214 may be a component fully incorporated within central unit 202, partially incorporated, or fully distinct from central unit 202, as desired for a particular configuration.

According to some embodiments, DSP 214 may be configured to receive audio input from remote microphones, process signals for beamforming, noise reduction, and echo cancellation, and then transmit the processed audio to speaker amplifiers or other output devices. DSP 214 may, in addition or alternatively, be configured to support dynamic audio routing, channel management, and zone-specific effects based on input from connected components. For example, DSP 214 may be configured to apply time-domain and frequency-domain algorithms to the input signals. For example, DSP 214 may be configured to perform Fast Fourier Transform (FFT) operations to convert signals into the frequency domain, where noise profiles can be analyzed and suppressed using adaptive filtering techniques. In beamforming applications, DSP 214 may be configured to process signals from multiple spatially separated microphones to isolate sound from a particular direction (e.g., a driver's voice) while minimizing interference from other sources. Echo cancellation may be implemented using adaptive filters that model and subtract feedback paths between speakers and microphones, which is especially useful in full-duplex communication scenarios. Such analyses of signals from microphones and sensors may be useful for noise cancellation, such as reducing the effects of traffic noise on the audio system.

DSP 214 alone or in combination with other components of central unit 202 (or other central unit) may be configured to handle multiple audio channels simultaneously, enabling parallel or sequential processing of input and output signals across the vehicle's audio system. Each audio channel may correspond to a unique signal from a particular device (e.g., audio device or sensor), and may be assigned to a dedicated processing pipeline within DSP 214 (or multiple channels may be processed simultaneously or together). DSP 214 may be configured to apply a series of filters to each channel, including high-pass filters to remove low-frequency noise (e.g., road rumble), low-pass filters to eliminate high-frequency interference, and band-pass filters to isolate speech or music content. In multi-channel configurations, DSP may 214 also be configured to perform channel mixing, splitting, or steering to support spatial audio rendering or adaptive playback strategies. Adaptive filtering techniques, such as Wiener or LMS (least mean squares) filters, may be employed to continuously refine the signal processing based on dynamic acoustic conditions within the vehicle cabin. For noise cancellation or beamforming, the DSP may analyze the phase and amplitude relationships across channels, adjusting filters in real time to improve the signal to noise ratio and overall audio quality. This filtering may be performed in both time and frequency domains, and may be controlled via software or hardware, including using feedback from environmental sensors or microphones.

In some embodiments, DSP 214 may be in communication with controller 216 and first master transceiver 210, and may further be configured to communicate a portion of the audio signals with first master transceiver 210. For example, the portion of audio signals may be downstream audio signals designated by first master transceiver 210 and controller 216 as destined for devices associated with second master bus 218 (e.g., loudspeakers, etc.) In another example, the portion of the audio signals may include upstream audio signals originating from devices associated with second master bus 218 (e.g., one or more microphones, etc.) and destined for central unit 202. The portion of the audio signals may be communicated through one or more channels designated by controller 216 to be used by second master transceiver 212.

DSP 214 may include or be in communication with an amplifier and one or more codecs, located in or near transceiver device 206, for processing audio signals or converting them between analog and digital signals. The one or more codecs may be configured to perform analog-to-digital and digital-to-analog conversions, while the amplifier may be configured to boost signal strength, thereby enabling seamless playback, recording, and signal conditioning within the audio system. For example, in addition to signal conversion and amplification, one or more codecs of DSP 214 may be configured to support multiple sampling rates and bit depths, enabling compatibility with various audio formats and system specifications. The one or more codecs may also include integrated digital filters and automatic gain control (AGC) to optimize signal fidelity and dynamic range. DSP 214 may interface with the codec via serial protocols like I²S or TDM, and may use DMA channels to offload data transfer, ensuring low-latency and high-throughput audio processing

In some embodiments, second master transceiver 212 may correspond to an initial node of a second plurality of nodes included in second master bus 218. For example, second master transceiver 212 may be responsible for discovery and enumeration of sub nodes or peripheral devices associated with second master bus 218. Second master transceiver 212 may perform audio signal and control signal routing to the intended peripheral devices. The second plurality of nodes may be linked to the first plurality of nodes through, for example, a node that includes first master transceiver 210. First master transceiver 210 may be positioned at a node linking both first master bus 204 and second master bus 218, and controller 216 may share this node as a part of transceiver device 206. Alternatively, controller 216 may correspond to a separate node (i.e., unshared node) in communication (e.g., direct communication) with first master transceiver 210 and second master transceiver 212.

Second master transceiver 212 may be in communication with DSP 214 and controller 216 to communicate at least some of the audio signals and the control signals with the second plurality of nodes via second master bus 218. Some of the audio signals may be the audio signals which were directed through channels coordinated by controller 216 or second master transceiver 212. In some embodiments, discovery and enumeration may be performed in part by controller 216. For example, controller 216 may be configured to initiate a discovery sequence by, for example, transmitting predefined signaling patterns or polling commands over second master bus 218 to identify active nodes and their capabilities. Further, the controller 216 may be configured to enumerate each node by assigning one or more logical addresses, configuring data paths, and updating routing tables within second master transceiver 212 to ensure synchronized audio and control signal distribution across the network.

In some embodiments, controller 216 may initiate second master transceiver 212, and this may be based in part on information received from first master bus 204 or first master transceiver 210. For example, controller 216 may assign addresses, roles, etc. for each node or device associated with second master bus 218, and coordinate timing of information between first master transceiver 210 and second master transceiver 212. For example, upon initiation of transceiver device 206, controller 216 may identify changes in network topology, including changes in any peripheral device connections or network information. In some embodiments, controller 216 may assess changes in device connections associated with first master bus 204 and use information obtained during the assessment to update one or more of protocols, parameters, control signals, and communication of audio signals through second master transceiver 212. For example, if a new peripheral device is added to a node associated with second master bus 218, then controller 216 may identify this change (either directly or through first master transceiver 212) and re-initialize second master transceiver 212 based on a combination of this information and information received from first master transceiver 210 or first master bus 204. For example, controller 216 may monitor changes via GPIO state or I²C polling, such as input from a connector switch or sensor, and may reinitialize the second transceiver accordingly.

DSP 214 and controller 216 may be independent of any DSP or controller that may be present in central unit 202. DSP 214, controller 216, first master transceiver 210, and second master transceiver 212 may be part of a standalone unit (i.e., transceiver device 206) that can be moved around in example audio system 230 (or any vehicle audio system). In some embodiments, the components of transceiver device 206 may be physically connected on the same board, but first master transceiver 210 and second master transceiver 212 may be separate chips. Being on separate chips may allow for independent function of the two transceivers, where second master transceiver 212 may be configured only to communicate directly with DSP 214 or controller 216. In some embodiments, the components of transceiver device 206 may be connected only via wiring or wirelessly and not located on the same physical board. In some embodiments, at least one of first master transceiver 210 or second master transceiver 212 may be configured to communicate wirelessly with the controller or the head unit. For example, the transceivers may use any suitable wireless protocol, e.g., Bluetooth, 802.11x, etc. to perform such communications. Such a configuration may allow for use over a larger area within the vehicle.

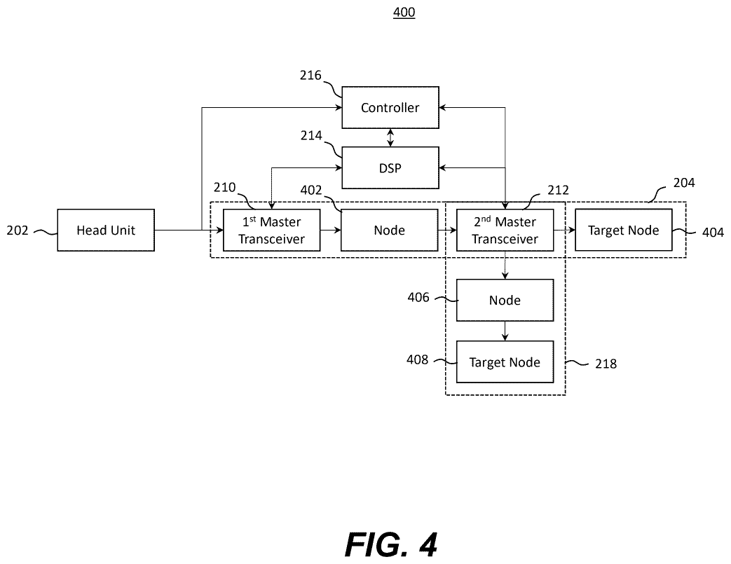

In some embodiments, bus nodes may be positioned between first master transceiver 210 and second master transceiver 212 (e.g., FIG. 4). For example, bus nodes may serve as signal repeaters, format converters, or peripheral interfaces that extend the reach and functionality. These nodes may regenerate audio and control signals to maintain signal integrity. Controller 216 and first and second master transceivers 210, 212 may coordinate timing and slot allocation to ensure deterministic data flow through these nodes.

In some embodiments, second master transceiver 212 may be configured to communicate with first master transceiver 210 through DSP 214. For example, second master transceiver 212 may not be in direct communication with first master transceiver 210, and instead, all audio signals directed through second master transceiver 212 (i.e., to second master bus 218) may be communicated through DSP 214. Controller 216 may be configured to communicate control signals to second master transceiver 212 for coordinating communication with peripheral devices via any of the nodes associated with second master bus 218. This architecture may allow DSP 214 to act as an audio routing and signal conditioning part of transceiver device 206, enabling flexible audio stream management between channels. DSP 214 may also perform audio format translation, buffering, and timing alignment to ensure compatibility and synchronization across disparate transceiver paths. The control signals may aid the second master transceiver 212 in determining the system arrangement of any downstream nodes, and to determine how to communicate the audio signals. For example, DSP 214 may manage format conversion, buffering, timing alignment, and/or channel routing to ensure a seamless handoff between master buses.

In some embodiments, the first plurality of nodes associated with first master bus 204 may include at least one intermediary node (e.g., node 206) configured to communicate at least first audio signals with target nodes 208a, 208b, 208c. As used herein, an intermediary node may correspond to any node on a master bus that is not a master transceiver or a target node (e.g., any of target nodes 208a, 208b, 208c, 222a, 222b, 222c). A target node may correspond to a peripheral node of an audio system (e.g., example audio system 230) that is either in communication with a peripheral device or is part of the peripheral device. In some embodiments, a target node (e.g., any of target nodes 208a, 208b, 208c, 222a, 222b, 222c) may be affixed to a peripheral device, for example.

The second plurality of nodes associated with second master bus 218 may include at least one other intermediary node (e.g., node 220) configured to communicate a portion of the control signals and at least second audio signals with target nodes 222a, 222b, 222c different from target nodes 208a, 208b, 208c. Since target nodes 222a, 222b, 222c are associated with second master bus 218 and target nodes 208a, 208b, 208c are associated with first master bus 204, the peripheral devices and nodes associated with each can be different (i.e., to establish different audio zones in a vehicle). Thus, the first and second audio signals may include any components of the audio stream, such as processed, filtered, or otherwise conditioned signals by DSP 214, that are routed through designated channels. These channels may be dynamically coordinated by second master transceiver 212 in conjunction with controller 216, ensuring that the relevant portions of the audio are properly distributed to the appropriate nodes. For example, one channel may be used to send some audio signals, coordinated by controller 216 or second master transceiver 212, to target node 208a, which may correspond to a particular speaker for which a particular filtering was done by DSP 214. In some embodiments, target node 208, 222 may be a peripheral device such as a speaker, a microphone (e.g., micro-electro-mechanical systems (MEMS) microphone), or a sensor.

Target nodes 208a, 208b, 208c, 222a, 222b, 222c may include nodes that are branching from an intermediary node (e.g., nodes 206, 220), or they may be nodes that are part of first master bus 204 or second master bus 218, as shown in FIG. 2B. In some embodiments, target node 208c may correspond to a node on the plurality of nodes associated with first master bus 204. In some embodiments, target node 222a may correspond to a node on the plurality of nodes associated with second master bus 218. In such configurations, the chained target node may form a part of a daisy chain of the plurality of nodes. For example, the target node may be a sub node configured to directly interface with a peripheral device, or it may be a peripheral device acting as a slave transceiver.

It should be understood that a node position (such as node 206, target nodes 208a, 208 b, 208 c, first master transceiver 210, second master transceiver 212, node 220, or target nodes 222a, 222b, 222c) may be any real or relative position of a device in the system. The device in the system may include a slave device (e.g., a sub node transceiver and/or slave transceiver), a master transceiver, a peripheral device, etc. For example, the position may be a particular part of a vehicle (e.g., a console, door, or seat), or the node position may be relative to adjacent nodes or other components of the audio system.

In some embodiments, a first target node (e.g., one of target nodes 208a, 208b, 208c) may be different from at least one intermediary node (e.g., node 206) associated with first master bus 204. Similarly, in some embodiments, a second target node (e.g., one of target nodes 222a, 222b, 222c) may be different from at least one other intermediary node (e.g., node 220 associated with second master bus 218. For example, the intermediary node may simply relay audio and control signals, as when intermediary node is not a target node. For example, the intermediary node (e.g., node 206 or node 220) may be a slave transceiver that relays audio and control signals to at least one target node (e.g., target node 208a, 208b, 222b, 222c) branching from the intermediary node. In some embodiments, the intermediary node (e.g., node 206 or node 220) may include a slave transceiver configured to communicate some of the audio signals or a portion of the control signals to target node 208, 222. The intermediary node may be part of a daisy chain and configured to allow communication of downstream and upstream audio and control signals along a bus, such as first master bus 204 or second master bus 218.

The audio systems may include further daisy chaining of transceiver device 206. For example, additional transceiver devices like transceiver device 206 may be added in place of existing nodes or added as new nodes in an existing master bus (e.g., first master bus 204). In some embodiments, a third master transceiver may be linked to first master bus 204. The second controller may interface with the third master transceiver to manage control signals. A second DSP may also be linked to both the third master transceiver and the second controller, to, for example, facilitate audio signal processing and routing. Additionally, the fourth master transceiver may serve as the initial node on a third master bus and communicate directly with both the second DSP and the second controller to support coordinated signal distribution across the new bus domain. For example, the third master transceiver (or second controller) could replace target node 208c in first master bus 204. In this example, a third master bus would be headed by the fourth master transceiver and initiated by the second controller or third master transceiver. Other than the differences in the particular configuration of devices, the operation of each of these components may be similar to the components of example audio system 230, as discussed with respect to FIG. 2B.

In some embodiments, a fifth master transceiver may be linked to master bus 218. A third controller may be in communication with the fifth master transceiver. A third DSP may be in communication with the fifth master transceiver and the third controller. A sixth master transceiver may include a fourth master bus. The sixth master transceiver may be in communication with the third DSP and the third controller. For example, the third master transceiver (or second controller) could replace target node 222a in master bus 218. In this example, the fourth master bus may be headed by the fifth master transceiver and initialized by the third controller or fifth master transceiver. Other than the differences in the particular configuration of devices, the operation of each of these components may be similar to the components of example audio system 230, as discussed with respect to FIG. 2B. It should be understood that any number of iterations or daisy chaining of transceiver device 206 or the like may be used along any number of master buses in any combination and at any node along the master buses. The flexibility of the master transceivers in transceiver device 206 to act in a master or slave configuration aids in this flexibility, as does the flexibility and configuration of the controller (e.g., controller 216).

It should be understood that while system architecture, such as that shown with respect to FIG. 2B, may support extensive expansion through additional master transceivers and daisy chaining configurations, the total audio and control data transmitted across any master bus may be restricted by maximum bandwidth constraints (e.g., the bandwidth constraints defined by a master transceiver and/or A²B protocol). To mitigate the risk of master bus saturation and maintain reliable data transmission, signal processing operations may be performed locally at each DSP level (e.g., in DSP 214). This distributed processing approach may reduce bandwidth demand on the master buses and support scalable system performance across multiple bus domains. Furthermore, a distributed DSP topology may enhance overall system efficiency by enabling each DSP to perform localized signal processing and routing. This configuration may allow master buses to carry a greater volume of audio and control data compared to a centralized DSP architecture (e.g., a DSP housed in the head unit), thereby improving scalability and performance in complex audio applications.

According to some embodiments, an additional node may be added to the first plurality of nodes in first master bus 204. The additional node may be positioned between a first and a last node of first master bus 204, for example, midway between. The additional node may correspond to a sub node and/or a slave transceiver, another transceiver device like transceiver device 206, a peripheral device, etc. Addition of an additional node may be detected upstream by a controller (e.g., controller 216) or master transceiver (e.g., first master transceiver 210). Upon recognition of the change, the master transceiver or controller may re-initialize first master bus 204, reassigning addressing and channel configurations for audio and control signals communications for associated devices.

According to some embodiments, a second additional node may be added to the second plurality of nodes in second master bus 218. The second additional node may be positioned between an initial node and a last node of second master bus 218. The second additional node may be a sub node and/or a slave transceiver, another transceiver device like transceiver device 206, or a peripheral device. Adding the second additional mode may be detected upstream by controller 216 or second master transceiver 212, which may be a part of transceiver device 206. Upon recognition of the change, second master transceiver 212 or controller may re-initialize second master bus 218, reassigning addressing and channel configurations for audio and control signals communications, among other things.

The audio system may include different audio zones in a vehicle, for example. In some embodiments, first master bus 204 may be located in a first physical location in the vehicle, and second master bus 218 may be located in a second physical location in the vehicle different from the first physical location. For example, first master bus 204 may be located in the console/dashboard of the vehicle, and second master bus 218 may be located in the doors. First master bus 204 may establish a first audio zone in the vehicle and second master bus 218 may establish a second audio zone in the vehicle. For example, each audio zone may represent a different part of the vehicle with different audio characteristics.

Each master bus may associate with its own independent set of transceivers, nodes, and peripheral devices, effectively establishing discrete audio zones. For example, first master bus 204 may define a front cabin zone servicing the driver and front passenger seats, while second master bus 218 may define a rear cabin or door-mounted zone, supporting localized microphones, speakers, or actuators in those areas. Each zone can operate with distinct signal routing, audio processing profiles, or content streams (e.g., navigation audio in the front, entertainment in the rear), enabling zoned playback, selective muting, and adaptive noise control. The segmentation into separate audio zones enhances the user experience by allowing individualized sound environments while reducing crosstalk and enabling more precise acoustic tuning for each region.

In some embodiments, a digital amplifier with a plurality of channels may be configured in intermediate connection between first and second master buses 204, 218 and target node 208, 222 and configured to amplify the audio signals. This intermediate configuration may allow the digital amplifier to receive audio signals transmitted over first or second master buses 204, 218, including audio signals processed or filtered from DSP 214, and apply channel-specific digital amplification processing before forwarding the processed audio signals to a target node 222. The digital amplifier may perform, for example, per-channel gain adjustment, equalization, dynamic range compression, etc. The digital amplifier may comprise a pulse-width modulation (PWM), a pulse-density modulation (PDM) amplifier, a smart amplifier, a differential amplifier, a bridge-tied load (BTL) amplifier, etc. Further, ADCs may be used for additional processing or filtering of audio signals. The digital amplifier may receive control signals from a controller (e.g., controller 216) to coordinate signal amplification by channel (or groups of channels).

In digital audio systems employing transceivers such as those used in A²B transceivers and A²B buses (particularly two-wire systems), two primary timing signals, bit clock (BCLK) and left-right clock (LRCLK), may be implemented to synchronize audio data transmission between components. The BCLK may correspond to a rate at which individual bits of audio data are transmitted to maintain proper serialization and deserialization across the audio bus. LRCLK, also known as the word-select or frame-sync signal, may, for example, toggle at the audio sample rate and delineate the boundaries of left and right (or other) channel audio data in stereo streams. For example, in time division multiplexing (TDM) audio modes, LRCLK may mark the beginning of a frame that may contain multiple audio channels, not just stereo. For example, in a traditional A²B system, the master transceiver typically generates both BCLK and LRCLK, distributing them along the bus to, for example, maintain timing coordination among connected nodes, including DSPs, amplifiers, and codecs. Accurate phase alignment of LRCLK and BCLK is desirable for maintaining audio fidelity and channel coherence, especially in systems involving multiple nodes distributed across the vehicle. For example, sub nodes may be configured to accept BCLK and LRCLK as input signals, synchronizing their internal clocks to the master's timing through phase-locked loops (PLL) or clock recovery circuits. Each component of transceiver device 206 may be capable of using BCLK and LRCLK for synchronizing clocks between components, or with other audio system components (e.g., components of example audio system 230), such as central unit 202.

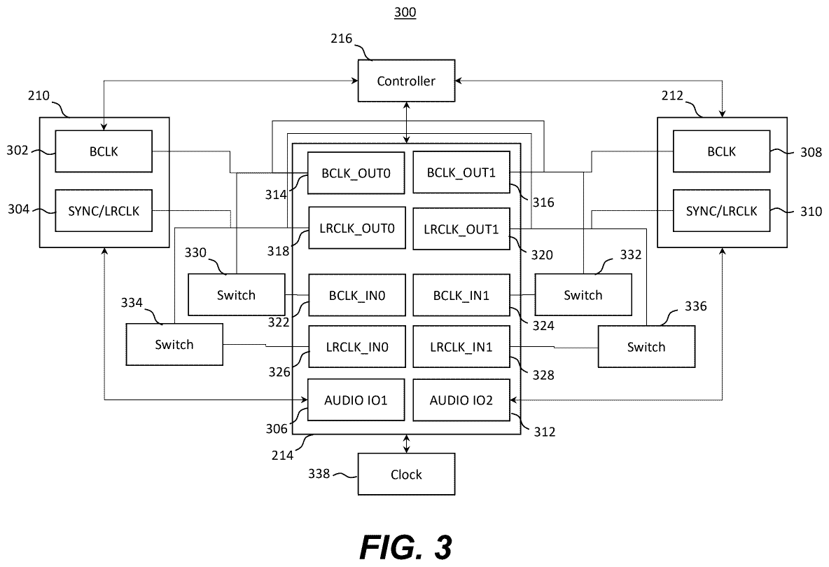

FIG. 3 is a diagram illustrating an example of clock signaling in an audio system, consistent with some disclosed embodiments. FIG. 3 incorporates by reference controller 216, first and second master transceivers 210, 212, and DSP 214 in transceiver device 206 of FIGS. 2A-2B. First master transceiver 210 may include clock components BCLK 302 and SYNC/LRCLK 304 and may be linked to AUDIO IO1 306 on DSP 214 for example, to relay audio signals between DSP 214 and first master transceiver 210 (e.g., audio signals from central unit 202 and traversing first master bus 204).

Second master transceiver 212 may include clock components BCLK 308 and SYNC/LRCLK 310 and be linked to AUDIO IO2 312 on DSP 214 for example, to relay audio signals. For example, audio signals may be relayed between DSP 214 and second master transceiver 212 to be communicated with devices associated with second master bus 218.

DSP 214 may include multiple pinouts associated with the BCLK and LRCLK, including BCLK_OUT0 314, BCLK_OUT1 316, LRCLK_OUT0 318, LRCLK_OUT1 320, BCLK_IN0 322, BCLK_IN1 324, LRCLK_IN0 326, and LRCLK_IN1 328. Switches 330, 332, 334, 336 may be positioned between a clock pin/port of DSP 214 and a clock pin/port of first or second master transceivers 210, 212. Clock 338 may be used for generating clock reference signals in a master configuration.

Synchronization of controller 216, DSP 214, first and second master transceivers 210, 212, and other devices in the audio system (e.g., example audio system 230) may be maintained, for example, by a clock circuit using internal (e.g., clock 338) and/or external clocks (e.g., from central unit 202) as a source.

In some embodiments, clock 338 may be used for generating a reference signal (e.g., when transceiver device 206 operates in a master mode) for coordinating deterministic timing of the control signals and the audio signals between controller 216, DSP 214, and first and second master transceivers 210, 212. In other embodiments, controller 216 may be used to generate a precise reference signal that establishes deterministic timing across various components of the audio system. For example, controller 216 may enable or disable a crystal oscillator to generate the precise reference signal. This reference clock may synchronize operation by, for example, serving as the basis for deriving bit clocks, frame sync signals, and timing boundaries necessary for coordinating communication between devices and ensuring that out of phase errors are minimized.

The reference clock may be sourced from a timing source, such as a crystal oscillator or a PLL circuit, providing a stable frequency (e.g., 24.576 MHz or 12.288 MHz, which may be desirable for standard audio sample rates such as 48 kHz or 96 kHz). Controller 216 may use this clock signal to time-stamp and sequence control packets, while DSP 214 may align its audio processing pipeline to the same timing domain to ensure frame-level determinism of audio signaling. When transceiver device 206 operates in slave mode, the clock circuit in transceiver device 206 may be synchronized with clock outputs of a master node or a master transceiver (e.g., at central unit 202). When switching between master or slave mode, a jumper for each device may be used to enable or disable external clocking. Master transceivers 210, 212 also may use this reference signal to generate the superframe (e.g., a time-based structure used to organize and transmit audio and control data) timing for coordinating downstream A²B (or similar) audio buses, ensuring that TDM audio slots are correctly framed and maintained with minimal jitter or other noise. This common timing architecture helps reduce drift, latency, or phase incoherence across channels, which is helpful in applications like active noise cancellation, spatialized audio playback, or microphone beamforming in a vehicle.

In some embodiments, the clock reference signal may be relayed through at least one switch 330, 332, 334, 336 for example, to establish at least one loopback between any combination of master transceiver 210, DSP 214, second master transceiver 212, and controller 216 for synchronizing the audio signals or the control signals. In other embodiments, loopbacks may not use a switch. For example, a direct connection of BCLK_OUT0 314 to BCLK_IN0 322 on DSP 214 may be implemented in lieu of switch usage.

Clock loopbacks may be implemented as external loopbacks that initiate from a device pin, connect to other device pins, and then loop back to another pin of the first device. For example, loopback connections may be used to synchronize first and second master transceivers 210, 212 to DSP 214, among other things. For example, a loopback may include a direct connection between LRCLK_OUT0 318 and LRCLK_IN0 326 for synchronization and timing validation. In this example, any of DSP 214, controller 216, or clock 338 (e.g., a crystal) may serve as the master for timing of the loopback, which may include dedicated lines from one of these masters, to their slaves (such as first or second master transceivers 210, 212, sub nodes, or peripheral devices), through switch 330, 332, 334, 336, then back to the master. In some embodiments, synchronization of the clock reference signal may be achieved through hardware-based timing alignment, without the need for digital signal processing. This may involve distributing a stable clock signal, such as one generated by a crystal oscillator, directly to relevant devices via dedicated lines or loopbacks. These hardware-level connections may allow devices to align their timing based on physical signal edges (e.g., rising or falling clock edges), to enable deterministic synchronization with lower computational cost. This may allow validating clock phase alignment across the devices, using PLLs or delay-locked loops (DLLs) for adjustments, thereby synchronizing all devices to allow for deterministic timing of audio and control signals relative to a common reference clock signal. For example, a pair of switches 330, 334 may create loopbacks for each of SYNC/LRCLK 304 and BCLK 302 on first master transceiver 210, another pair of switches 332, 336 may create loopbacks for each of SYNC/LRCLK 310 and BCLK 308 on second master transceiver 212 (e.g., by connecting to their respective ports/pins on DSP 214). BCLK 302 and SYNC/LRCLK 304 and BCLK 308 and SYNC/LRCLK 310 may each be connected respectively between first master transceiver 210 and second master transceiver 212 for synchronization of clock signals, while audio and control signals communicate between master transceivers 210, 212 and DSP 214 and controller 216, providing improved data synchronization and coordination between devices in transceiver 206 and the audio system.

In some embodiments, a loopback for DSP 214 may include a resistor (not shown in FIG. 3) between a BCLK output of DSP 214 and BCLK input of DSP 214. Similarly, the loopback for DSP 214 may include a resistor between a LRCLK output of DSP 214 and LRCLK input of DSP 214. For example, a resistor may be positioned in a direct loopback between BCLK_OUT0 314 and BCLK_IN0 322. The resistor may be any resistance value, including, for example, 1, 5, 10, 20, 30, 33, 40, 50, 100, 1000Ω, or any resistance value between. For example, a resistor having a resistance of 33Ω may be chosen based on the particular circuitry and operation of DSP 214 or other components of transceiver device 206. For example, a resistor with particular resistance may be used for impedance matching, current limiting, or signal conditioning. In some embodiments, a variable resistor may be used to enable controllably varying the resistance of the resistor (e.g., for tuning.)

In some embodiments, DSP 214 may include separate loopbacks ports, pins, and/or channels for each device to be synchronized. In some embodiments, a BCLK output of DSP 214 may be linked through the resistor to a BCLK input of DSP 214, which may be linked to the BCLK input of first master transceiver 210. For example, BCLK_OUT0 314 may be linked to BCLK_IN0 322 through a resistor of, for example, 33Ω and BCLK_IN 0 322 may be linked directly to BCLK 302. In some embodiments, another BCLK output of DSP 214 may be linked through the resistor to another BCLK input of DSP 214, which may be linked to the BCLK input of second master transceiver 212. Again, the values mentioned for resistance of the resistor are not intended as limiting, and may be varied as desired without departing from the scope of the present application.

Where transceiver device 206 is configured as a sub node or slave device, first master transceiver 210 may include a SYNC signal from first master bus 204, which may be connected to an input port or pin on DSP 214 (e.g., an MP6 pin). This SYNC/LRCLK signal may originate from an upstream master device, such as a central unit 202 or a master transceiver. This input may then be used as a reference for the clock of DSP 214 (e.g., CLKGEN3 module), which may generate a PLL-based clock. By locking this local PLL to the incoming SYNC/LRCLK signal, DSP 214 may, for example, regenerate its own synchronized BCLK and SYNC/LRCLK, effectively aligning its internal clock domain with the clock signals originating from first master bus 204 (e.g., from another master transceiver or central unit 202), and synchronizing BCLK 302, SYNC/LRCLK 304, BCLK 308, and SYNC/LRCLK 310. PLL for DSP 214 may support the exact sample rate used by a master transceiver to ensure proper synchronization and avoid timing mismatches across the audio system.

In some embodiments, a jumper may be used between two ports of BCLK outputs or inputs or between two ports of LRCLK outputs or inputs for DSP 214. For example, a jumper between BCLK_OUT0 314 and BCLK_OUT1 316 of DSP 214 may allow the BCLK_OUT1 316 to be clocked to BCLK_OUT0 314. In another example, a jumper between LRCLK_OUT0 318 and LRCLK_OUT1 320 of DSP 214 may allow LRCLK_OUT1 320 to be driven by LRCLK_OUT0 318. For example, these ports may be bidirectional for clock signaling to allow switching of devices in transceiver 206 or the audio system between master and slave configuration, depending on the connections and jumper orientation.

FIG. 4 is a diagram illustrating example audio system 400 including two master transceivers, consistent with some disclosed embodiments. FIG. 4 incorporates by reference central unit 202, first and second master transceivers 210, 212, DSP 214, controller 216, and first and second master buses 204, 218 from FIGS. 2A-3.

Audio and control signals may originate, for example, from central unit 202. Central unit 202 may be in communication with controller 216 or DSP 214. In this configuration, first master transceiver 210 may correspond to a first node of first master bus 204 and configured to communicate audio and control signals to intermediary nodes (e.g., node 402) or target nodes (target node 404) on first master bus 204. Second master transceiver 212 may be linked to first master bus 204, and second master transceiver 212 may be included in second master bus 208 and configured to communicate audio and control signals to other intermediary nodes (e.g., node 406) or target nodes (target node 408) on second master bus 218. DSP 214 may communicate audio signals with first master transceiver 210 and second master transceiver 212. Controller 216 may communicate control signals with DSP 214, first master transceiver 210, and second master transceiver 212, among others.

First master transceiver 210 may communicate a portion of the control signals between controller 216 and intermediary nodes, and may communicate a portion of the audio signals between DSP 214 and target node 404. Second master transceiver 212 may be linked to first and second master buses 204, 208 through an intervening node on first master bus 204, which may be any node that is not the node including the first master transceiver 210. Second master transceiver 212 may be configured to communicate a second portion of the control signals between controller 216 and at least one other intermediary node (e.g., node 406), and to communicate a second portion of the audio signals between DSP 214 and a second target node (e.g., target node 408) via second master bus 218. The control signals may be configured to coordinate communication of the audio signals via one or more of first master transceiver 210 and second master transceiver 212. This configuration may lead to further flexibility and adaptability of the audio system.

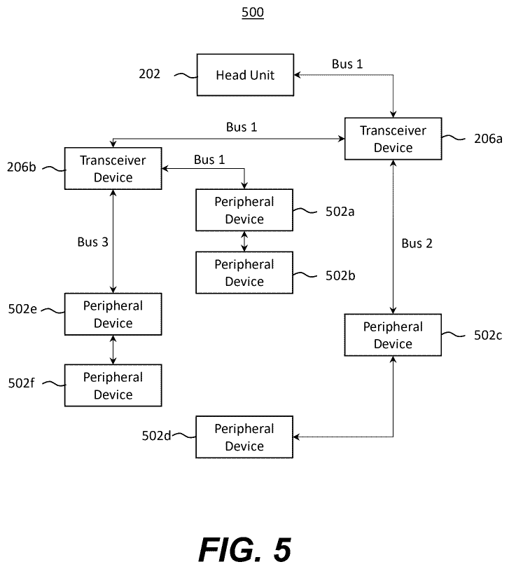

FIG. 5 is a diagram illustrating an example implementation of an audio system in a vehicle, consistent with some disclosed embodiments. FIG. 5 incorporates by reference central unit 202 and transceiver device 206 from FIGS. 2A-4. Central unit 202 may be configured to communicate audio and control signals along bus 1 to transceiver device 206a. Transceiver device 206a may communicate the signals to transceiver device 206b through bus 1. Transceiver device 206b may communicate signals with peripheral devices 502a, 502b via bus 1. Transceiver device 206a may communicate at least some of the audio and control signals with peripheral devices 502c, 502d via bus 2 (e.g., through a second master transceiver in transceiver device 206a). Transceiver device 206b may communicate at least some of the audio and control signals to peripheral devices 502e, 502f (e.g., through a second master transceiver in transceiver device 206b) via bus 3. Transceiver devices 206a, 206b may each include any of the components and functions described previously with respect to transceiver device 206. Peripheral devices 502 may include any audio devices or sensors, and may be connected to target nodes in the audio system, as described previously. In FIG. 5, the transceiver devices 206a, 206b are implemented to provide a more distributed audio system with better control, flexibility, and adaptability. Placement of each transceiver device 206 may be dependent upon the desire to establish individual audio zones in the vehicle. It should be understood that additional transceiver devices may be flexibly placed at any node in the audio system to provide increased accessibility or adaptability of the system to changes in the vehicle, and/or for customizing a particular audio system within the vehicle.

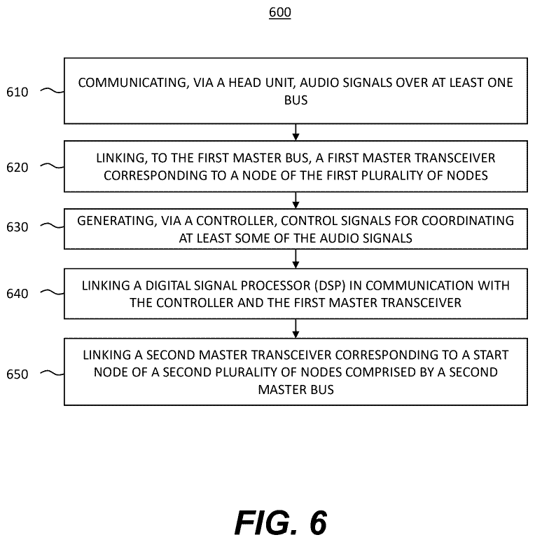

FIG. 6 is a flowchart illustrating process 600 for implementing an audio system in a vehicle, consistent with some disclosed embodiments. Process 600 describes a method to improve flexibility and adaptability of an audio system. Process 600 may implement any and all functions, components, and combinations thereof, as presented in any of FIGS. 2-5 or described previously. For example, process 600 may use transceiver device 206 of FIGS. 2A-3 in performing any of the steps of process 600. Alternatively, any of the transceivers discussed above may be implemented alone or in combination for carrying out the steps of process 600. The components of FIGS. 2A-5 are incorporated by reference with respect to process 600.

Step 610 of process 600 may include communicating, via a central unit, audio signals over at least one bus. The at least one bus may be configured to include a first master bus. The first master bus may include a first plurality of nodes. The central unit (e.g., central unit 202) may be configured to communicate audio and control signals along the master bus (e.g., first master bus 204). The plurality of nodes may be configured to include intermediary nodes, target nodes, or other master transceivers, such as first master transceiver 210. The nodes may be sub nodes and/or slave transceivers to the central unit.

Step 620 of process 600 may include linking, to the first master bus, a first master transceiver corresponding to a node of the first plurality of nodes. For example, first master transceiver 210 may be a node on first master bus 204. Audio and control signals may be communicated through first master transceiver 210 to other nodes, and audio and control signals may be received by transceiver device 206.

Step 630 of process 600 may include generating, via a controller, control signals for coordinating at least some of the audio signals. The control signals may communicate with master transceivers and assess information from the first master transceiver, along with downstream system information (i.e. from nodes or peripheral devices), to determine how to coordinate the signaling in the system. For example, controller 216 may receive information from first master transceiver 210, and downstream devices (e.g., through second master transceiver 212 or second master bus 218) and determine how to coordinate signaling, thereby generating control signals for the coordinated signaling.

Step 640 of process 600 may include linking a DSP in communication with the controller and the first master transceiver. The DSP may be configured to communicate a portion of the audio signals with the first master transceiver. The DSP may be responsible for processing and handling the audio signals, particularly for downstream devices (e.g., those devices associated with second master bus 218). For example, first master transceiver 210 may be in communication with DSP 214 for clock signals and audio signals, and DSP 214 may be in communication with controller 216 for synchronization and timing.

Step 650 of process 600 may include linking a second master transceiver corresponding to an initial node of a second plurality of nodes included in a second master bus. The second plurality of nodes may be linked to the first plurality of nodes through the node. The second master transceiver may be in communication with the DSP and the controller to communicate the at least some of the audio signals and the control signals with the second plurality of nodes via the second master bus. The master buses may be linked through a master transceiver (e.g., through transceiver device 206). The placement of the transceiver device and its components may be at any node along the master bus. For example, transceiver device 206 may be positioned as a first node, last node, or any intermediary node of first master bus 204. The controller may use the information from the first master transceiver and downstream devices to initialize the second master transceiver. For example, controller 216 may receive control information through first master transceiver 210, and downstream peripheral devices configuration information through second master transceiver 212, and controller 216 may determine how to configure the downstream devices based on this information. For example, controller 216 may use a predefined setup (e.g., predefined register writes), such as Discover Flow™ when initializing second master bus 218, while allowing for dynamic setup. Accordingly, a portion of the audio signals and control signals may be communicated with associated nodes or peripheral devices connected through second master bus 218. In this way, the audio system provides enhanced flexibility, as changes in the audio system, including adding new components, can be easily accommodated.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of . Net Framework, . Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. An audio system for a vehicle, the audio system comprising:
a central unit configured to communicate audio signals over at least one bus, the at least one bus comprising a first master bus, wherein the first master bus comprises a first plurality of nodes;
a first master transceiver corresponding to a node of the first plurality of nodes;
a controller in communication with the central unit and the first master transceiver, wherein the controller is configured to generate control signals for coordinating at least some of the audio signals;
a digital signal processor (DSP) in communication with the controller and the first master transceiver, wherein the DSP is configured to communicate a portion of the audio signals with the first master transceiver; and
a second master transceiver corresponding to an initial node of a second plurality of nodes comprised by a second master bus, the second plurality of nodes being linked to the first plurality of nodes through the node, wherein the second master transceiver is in communication with the DSP and the controller to communicate the at least some of the audio signals and the control signals with the second plurality of nodes via the second master bus.

2. The audio system of claim 1, wherein the first plurality of nodes comprises at least one intermediary node configured to communicate at least first audio signals with at least one first target node, and the second plurality of nodes comprises at least one other intermediary node configured to communicate a portion of the control signals and at least second audio signals with at least one second target node different from the at least one first target node.

3. The audio system of claim 2, wherein the at least one first target node corresponds to a second node on the first plurality of nodes.

4. The audio system of claim 2, wherein the at least one second target node corresponds to a third node on the second plurality of nodes.

5. The audio system of claim 2, wherein the at least one first target node is different from the at least one intermediary node.

6. The audio system of claim 5, wherein the at least one intermediary node comprises a sub node transceiver configured to communicate the at least first audio signals to the at least one first target node.

7. The audio system of claim 2, wherein the at least one second target node is different from the at least one other intermediary node.

8. The audio system of claim 7, wherein the at least one other intermediary node comprises a second sub node transceiver configured to communicate the portion of the control signals and the at least one second audio signals with the at least one second target node.

9. The audio system of claim 1, wherein the at least one first or second target node comprises at least one peripheral device comprising at least one of a speaker, a microphone, or a sensor.

10. The audio system of claim 1, wherein the first master transceiver is configured to communicate the audio signals directly with the central unit.

11. The audio system of claim 1, wherein the controller is configured to communicate the audio signals directly with the central unit and directly with the first master transceiver.

12. The audio system of claim 1, wherein at least one of the first master transceiver or the second master transceiver is configured to communicate wirelessly with the controller or the central unit.

13. The audio system of claim 1, further comprising:
a third master transceiver linked to the first master bus;
a second controller in communication with the third master transceiver;
a second DSP in communication with the third master transceiver and the second controller; and
a fourth master transceiver acting as an initial node for a third master bus, the fourth master transceiver in communication with the second DSP and the second controller.

14. The audio system of claim 13, further comprising:
a fifth master transceiver linked to the second master bus;
a third controller in communication with the fifth master transceiver;
a third DSP in communication with the fifth master transceiver and the third controller; and
a sixth master transceiver acting as another initial node for a fourth master bus, the sixth master transceiver in communication with the third DSP and the third controller.

15. The audio system of claim 2, further comprising at least one digital amplifier comprising a plurality of channels, the at least one digital amplifier in intermediate connection between the second master bus and the at least one second target node and configured to amplify the at least second audio signals.

16. The audio system of claim 1, further comprising a clock for generating a reference signal, wherein the reference signal is provided to at least one of the DSP or the controller for coordinating deterministic timing of the control signals and the audio signals between the controller, the DSP, and the first and second master transceivers.

17. The audio system of claim 16, wherein the reference signal is relayed through at least one switch for establishing at least one loopback between any combination of the first master transceiver, the DSP, the second master transceiver, and the controller for synchronizing the audio signals or the control signals.

18. The system of claim 1, wherein the first master bus is located in a first physical location in the vehicle and the second master bus is located in a second physical location in the vehicle different from the first physical location, and wherein the first master bus establishes a first audio zone in the vehicle and the second master bus establishes a second audio zone in the vehicle.

19. The audio system of claim 1, wherein the second master transceiver is configured to communicate with the first master transceiver through the DSP.

20. A method for a vehicle audio system, the method comprising:
communicating, via a central unit, audio signals over at least one bus, the at least one bus comprising a first master bus, wherein the first master bus comprises a first plurality of nodes;
linking, to the first master bus, a first master transceiver corresponding to a node of the first plurality of nodes;
generating, via a controller, control signals for coordinating at least some of the audio signals;
linking a digital signal processor (DSP) in communication with the controller and the first master transceiver, the DSP configured to communicate a portion of the audio signals with the first master transceiver; and
linking a second master transceiver corresponding to an initial node of a second plurality of nodes comprised by a second master bus, the second plurality of nodes being linked to the first plurality of nodes through the node, wherein the second master transceiver is in communication with the DSP and the controller to communicate the at least some of the audio signals and the control signals with the second plurality of nodes via the second master bus.

21. The method of claim 20, further comprising adding an additional node to the first plurality of nodes in the first master bus, the additional node positioned between a first and a last node of the first master bus.

22. The method of claim 20, further comprising adding a second additional node to the second plurality of nodes in the second master bus, the second additional node positioned between the initial node and a last node of the second master bus.

23. The method of claim 20, further comprising adding a third and fourth master transceiver, a second controller, and a second DSP to the first or second master bus.

24. The method of claim 20, further comprising initializing, by the controller, the second bus, based on the first bus and the audio signals.

25. An audio system for a vehicle, the audio system comprising:
a central unit configured to communicate audio signals and control signals over at least one bus, the at least one bus comprising a first master bus, wherein the first master bus comprises a first plurality of nodes;
a first master transceiver corresponding to a node of the first plurality of nodes;
a controller in communication with the central unit and the first master transceiver, wherein the controller is further configured to receive information from the first master transceiver and downstream device information to generate control signals for coordinating at least some of the audio signals;
a digital signal processor (DSP) in communication with the controller and the first master transceiver, the DSP configured to communicate a portion of the audio signals with the first master transceiver; and
a second master transceiver corresponding to an initial node of a second plurality of nodes comprised by a second master bus, the second plurality of nodes being linked to the first plurality of nodes through the node, wherein the second master transceiver is in communication with the DSP and the controller to communicate the at least some of the audio signals and the control signals with the second plurality of nodes via the second master bus,
wherein the second master transceiver communicates the downstream device information with the controller, and
wherein the DSP is configured with loopbacks for coordinating clock signals between the controller, the DSP, and the first and second master transceivers.
